(19) United States
(12) Patent Application Publication
(10) Pub. No.: US 2025/0274217 A1
(43) Pub. Date: Aug. 28, 2025

(54) PREDICTING HYBRID ARQ (HARQ) SUCCESS USING MACHINE LEARNING

(71) Applicant: TELEFONAKTIEBOLAGET LM ERICSSON (PUBL), Stockholm (SE)

(72) Inventors: Zaigham Kazmi, Austin, TX (US); Emre Gonultas, Austin, TX (US); Swathi Priya Dhandapani, Austin, TX (US)

(21) Appl. No.: 19/188,212

(22) Filed: Apr. 24, 2025

Related U.S. Application Data
(63) Continuation-in-part of application No. PCT/IB2023/061085, filed on Nov. 2, 2023.
(60) Provisional application No. 63/639,829, filed on Apr. 29, 2024.

(51) Int. Cl. H04L 1/00; H04L 1/1812

(52) U.S. Cl. CPC H04L 1/0003; H04L 1/1812

(57) ABSTRACT

Embodiments include methods performed by a radio access network (RAN) node. Such methods include, prior to a first packet being transmitted, predicting likelihood of decoding success by a receiver of the first packet, using a machine learning (ML) model with the following inputs: one or more parameters representative of characteristics of a radio channel over which the first packet will be transmitted during a plurality of regularly spaced time periods (e.g., slots) preceding the transmission of the first packet, and candidates of one or more of the following for the first packet: modulation and coding scheme (MCS), and number of physical resource blocks (PRBs). Such methods include obtaining a first MCS and/or a first number of PRBs to be used for transmitting the first packet, based on the candidate(s) and the predicted likelihood of decoding success. Such methods include transmitting or receiving the first packet using the obtained first MCS and/or first number of PRBs.

### RELATED APPLICATIONS

The present application is a continuation-in-part of International Application No. PCT/IB 2023/061085, filed Nov. 22, 2023, and claims priority to U.S. Provisional Patent Application No. 63/639,829, filed Apr. 29, 2024, entitled “PREDICTING HYBRID ARQ (HARQ) SUCCESS USING MACHINE LEARNING,” the disclosures of which are hereby incorporated herein by reference in their entirety.

### TECHNICAL FIELD

The present disclosure relates generally to wireless networks, and more specifically to techniques for radio access network (RAN) nodes to select various transmission parameters based on likelihood of decoding success predicted using a machine learning (ML) model.

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN, 199) and a 5G Core (5GC, 198). As shown in the figure, NG-RAN 199 can include gNBs (e.g., 110a,b) and ng-eNBs (e.g., 120a,b) that are interconnected with each other via respective Xn interfaces. The gNBs and ng-eNBs are also connected via the NG interfaces to the 5GC, more specifically to Access and Mobility Management Functions (AMFs, e.g., 130a,b) via respective NG-C interfaces and to User Plane Functions (UPFs, e.g., 140a,b) via respective NG-U interfaces. Moreover, the AMFs can communicate with one or more policy control functions (PCFs, e.g., 150a,b) and network exposure functions (NEFs, e.g., 160a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 111a-b, 121a-b). Depending on the cell in which it is located, a UE (105) can communicate with the gNB or ng-eNB serving that cell via the NR or LTE radio interface, respectively. Although FIG. 1 shows gNBs and ng-eNBs separately, it is also possible that a single NG-RAN node provides both types of functionality.

Each of the gNBs may include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, multiple TRPs can transmit different versions of a signal to a single UE. Each TRP can use beams for transmission/reception with UEs served by the gNB, as discussed below.

5G/NR technology shares many similarities with fourth-generation LTE. For example, NR uses CP-OFDM (Cyclic Prefix Orthogonal Frequency Division Multiplexing) in the downlink (DL) and either CP-OFDM or DFT-spread OFDM (DFT-S-OFDM) in the uplink (UL). As another example, in the time domain, NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval.

In addition to providing coverage via “cells,” as in LTE, NR networks also provide coverage via “beams.” In general, a DL “beam” is a coverage area of a network-transmitted reference signal (RS) that may be measured or monitored by a UE. In NR, for example, DL RS can include any of the following: SS/PBCH block (SSB), channel state information (CSI) RS, tertiary RS (or any other sync signal), positioning RS (PRS), demodulation RS (DMRS), phase-tracking RS (PTRS), etc. UL RS include sounding RS (SRS) and DMRS.

The physical UL shared channel (PUSCH) carries user data and signaling from UE to gNB, while the physical DL shared channel (PDSCH) carries user data and signaling from gNB to UE. Each gNB internally maintains a state of the UE-specific channel over which PUSCH and PDSCH are transmitted and received. This state is often referred to as Channel State For Link Adaptation (CS4LA). DL CS4LA is based on channel state information (CSI) provided by the UE via CSI reports, including information such as channel quality indicator (CQI), rank indicator (RI), RS received power (RSRP), etc. UL CS4LA is based on channel quality measured on UE transmissions of PUSCH and/or RS (e.g., SRS, DMRS). To account for measurement inaccuracies and the fact that the channel changes over time, the gNB may apply an offset to the estimated CS4LA to obtain an effective CS4LA with less capacity.

For each data packet transmitted via PDSCH or PUSCH, the gNB maps the effect CS4LA to a corresponding modulation and coding scheme (MCS) to be used for the data packet. For DL, the gNB uses the obtained MCS for transmitting the data packet via PDSCH. For UL, the gNB sends the UE an indication of the obtained MCS, which the UE uses for transmitting the data packet via PUSCH. In either case, the gNB obtains feedback on whether the data packet was successfully received. In the DL, this involves the UE sending hybrid ARQ (HARQ) feedback to the gNB via physical UL control channel (PUCCH) or physical UL shared channel (PUSCH). For the UL, the gNB receiver is aware of its own success or failure of decoding the data packet.

If the data packet was successfully received, the gNB will increase the CS4LA by an amount called “step-up”, indicating an increase in channel capacity which may map to a less robust MCS with higher data capacity. If the data packet was not successfully received, the gNB will reduce the CS4LA by an amount called “step-down”, indicating a decrease in channel capacity and a corresponding more robust MCS with lower data capacity. To maintain a reasonable block (or packet) error rate (BLER) target such as 1%, step-down is typically much larger than step-up, e.g., step-down=100·step-up.

### SUMMARY

Although this relation between step-up and step-down helps the gNB to maintain transmission performance according to a BLER target, applying the large step-down value causes a link (e.g., UL or DL) to operate at a much reduced capacity for an extended duration until many smaller step-up values have been applied. Since radio resources are scarce, it is desirable to use as much as possible of actual channel capacity at any given time (e.g., with appropriate MSC), while maintaining performance according to relevant BLER targets. Accordingly, there is a need for techniques for determining the most appropriate MCS to meet these goals.

An object of embodiments of the present disclosure is to improve communication between UEs and RAN nodes (e.g., gNBs), such as by providing, enabling, and/or facilitating solutions to exemplary problems summarized above and described in more detail below.

Embodiments include methods (e.g., procedures) performed by a RAN node for communication with one or more UEs.

These exemplary methods include, prior to a first packet being transmitted, predicting likelihood of decoding success by a receiver of the first packet, using a machine learning (ML) model with the following inputs:
one or more parameters representative of characteristics of a radio channel over which the first packet will be transmitted, wherein the one or more parameters represent characteristics of the radio channel during a plurality of regularly spaced time periods preceding the transmission of the first packet, and
candidates of one or more of the following for the first packet: modulation and coding scheme (MCS), and number of physical resource blocks (PRBs);

These exemplary methods also include obtaining a first MCS and/or a first number of PRBs to be used for transmission of the first packet, based on the one or more candidates and the predicted likelihood of decoding success. These exemplary methods also include transmitting or receiving the first packet using the obtained first MCS and/or first number of PRBs.

In some embodiments, the exemplary method can also include the following operations:
maintaining a channel state for link adaptation (CS4LA) based on one or more of the following: the indications of decoding success or failure reported by the one or more UEs for the DL packets, and the indications of decoding success or failure by the RAN node for the UL packets; and.
obtaining the candidate MCS based on the CS4LA.

In some embodiments, the ML model is a recurrence neural network (RNN) comprising an input layer configured to receive input, an output layer configured to output a predicted likelihood of decoding success by a receiver of the first packet, and two or more fully connected hidden layers intermediate between the input layer and the output layer.

In some of these embodiments, each of the hidden layers is configured to generate a plurality of outputs based on respective first activation functions, various examples of which are described herein. Also, the predicted likelihood of decoding success is generated by the output layer based on the outputs of one of the hidden layers and one or more second activation functions, various examples of which are described herein.

In some of these embodiments, the input to the input layer is a feature vector and predicting likelihood of decoding success by a receiver of the first packet using the ML model includes determining the feature vector based on a function of the candidate MCS for the first packet and the one or more parameters representative of characteristics of the radio channel over which the first packet will be transmitted.

Various examples of the parameters representative of characteristics of the radio channel are disclosed herein.

Other embodiments include RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such RAN nodes to perform operations corresponding to any of the exemplary methods described herein.

These and other embodiments described herein do not require any changes to existing standards, nor any additional signaling between RAN and UE or within the RAN. Furthermore, the ML model predictor can be used as a plug-in to any existing link adaptation implementation within the RAN, only requiring a relatively small amount of additional baseband processing for ML prediction. Moreover, by proper MCS and/or PRB selection, embodiments can improve a combination of BLER, latency, and data throughput, which can be very useful for certain UEs (e.g., URLLC) that require this combination of performance.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary 5G/NR network architecture.

FIG. 2 shows exemplary NR UP and CP protocol stacks.

FIG. 3 shows an exemplary time-frequency resource grid for an NR slot.

FIG. 4 shows an exemplary step-up/step-down arrangement for estimated CS4LA maintained by a gNB.

FIG. 5 shows a conventional link adaptation procedure for a DL from a RAN (e.g., a serving gNB) to a UE.

FIG. 6 shows a conventional link adaptation procedure for an UL from a UE to a RAN (e.g., a serving gNB).

FIG. 7 shows an exemplary scenario that illustrates wasted channel capacity by conventional link adaptation techniques.

FIG. 8 shows a link adaptation procedure for a DL from a RAN (e.g., a serving gNB) to a UE (820), according to some embodiments of the present disclosure.

FIG. 9 shows an example scenario that further illustrates operation of the exemplary link adaptation procedure shown in FIG. 8.

FIG. 10 shows an example scenario that illustrates other link adaptation techniques for a DL, according to other embodiments of the present disclosure.

FIG. 11 shows a link adaptation procedure for an UL from a UE to a RAN (e.g., a serving gNB), according to other embodiments of the present disclosure.

FIG. 12 shows a simplified deep neural network (DNNs) structure that can be used in some embodiments of the present disclosure.

FIG. 13 shows a flowchart for how a DNN can be used in some embodiments of the present disclosure.

FIG. 14 shows a flow diagram of a procedure that can be used to evaluate performance of a DNN used in some embodiments of the present disclosure.

FIG. 15 shows a graph of a confusion matrix that illustrates performance of a DNN used in some embodiments of the present disclosure.

FIG. 16 (which includes FIGS. 16A-B) shows a flow diagram of an exemplary method for a RAN node (e.g., base station, eNB, gNB, ng-eNB, etc.), according to various embodiments of the present disclosure.

FIG. 17 shows a communication system according to various embodiments of the present disclosure.

FIG. 18 shows a UE according to various embodiments of the present disclosure.

FIG. 19 shows a network node according to various embodiments of the present disclosure.

FIG. 20 is a block diagram of a virtualization environment in which functions implemented by some embodiments of the present disclosure may be virtualized.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

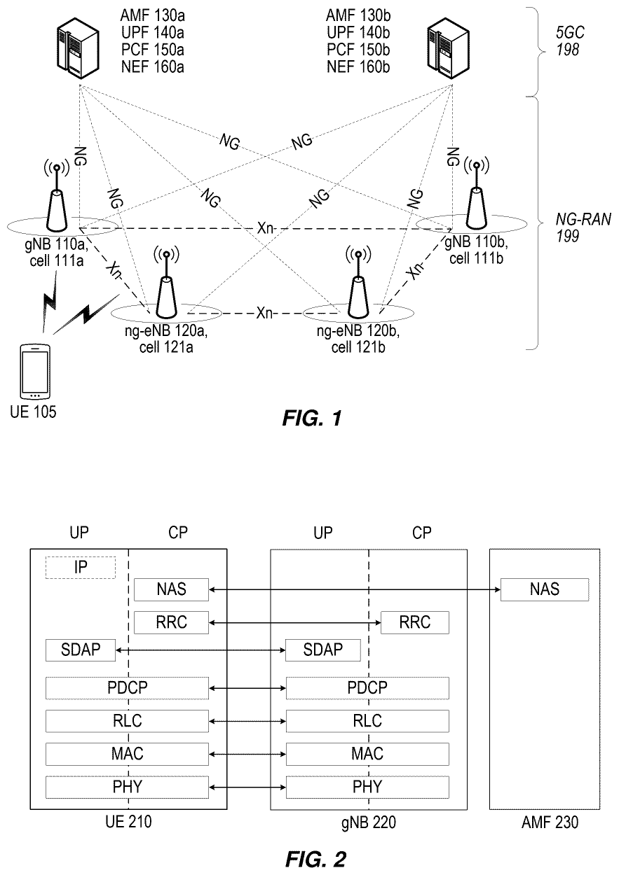

FIG. 2 shows an exemplary configuration of NR user plane (UP) and control plane (CP) protocol stacks between a UE (210), a gNB (220), and an AMF (230), such as those shown in FIG. 1. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to M A C and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC INACTIVE state in which a UE is known (e.g., via UE context) by the serving gNB. RRC INACTIVE has some properties similar to a “suspended” condition used in LTE.

In 3GPP Release-15 (Rel-15), an NR UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL (SUL), the UE can be configured with up to four additional BWPs in the SUL, with a single SUL BWP being active at any time.

Common RBs (CRBs) are numbered from 0 to the end of the carrier bandwidth. Each BWP configured for a UE has a common reference of CRB0, such that a configured BWP may start at a CRB greater than zero. CRB0 can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. Within a BWP, physical resource blocks (PRBs) are defined and numbered in the frequency domain from 0 to N_{BWP,i}^{size}-1, where i is the index of the BWP of the carrier.

NR supports various SCS values Δf=(15×2^{μ}) kHz, where μ∈ (0,1,2,3,4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is related to numerology according to 2^{μ}*50 MHz. Different DL and UL numerologies can be configured by the network.

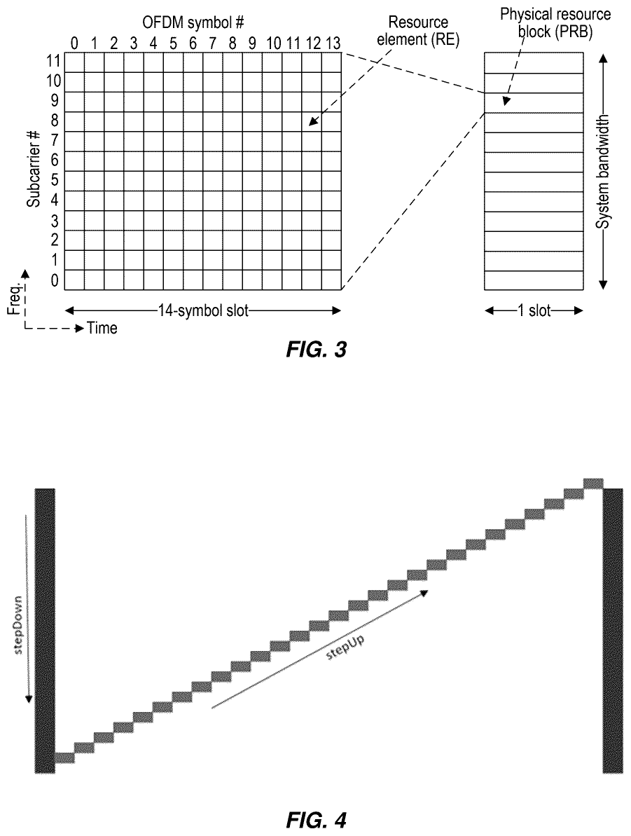

FIG. 3 shows an exemplary time-frequency resource grid for an NR slot. As illustrated in FIG. 3, a PRB consists of a group of 12 contiguous OFDM subcarriers for a duration of a 14-symbol slot. Like in LTE, a resource element (RE) consists of one subcarrier in one symbol. An NR slot can include 14 OFDM symbols for normal cyclic prefix and 12 symbols for extended cyclic prefix.

In general, an NR physical channel corresponds to a set of REs carrying information that originates from higher layers. Downlink (DL, i.e., RAN node to UE) physical channels include Physical Downlink Shared Channel (PDSCH), Physical Downlink Control Channel (PDCCH), and Physical Broadcast Channel (PBCH). Uplink physical channels include Physical Uplink Shared Channel (PUSCH), Physical Uplink Control Channel (PUCCH), and Physical Random-Access Channel (PRACH). PUSCH is the uplink counterpart to the PDSCH. PUCCH is used by UEs to transmit uplink control information (UCI) including HARQ feedback for RAN node DL transmissions, channel quality feedback (e.g., CSI) for the DL channel, scheduling requests (SRs), etc. PRACH is used for random access preamble transmission.

PDSCH is the main physical channel used for unicast DL data transmission, but also for transmission of random access response (RAR), certain system information blocks (SIBs), and paging information. PB CH carries the basic system information (SI) required by the UE to access a cell. PDCCH is used for transmitting DL control information (DCI) including scheduling information for DL messages on PDSCH, grants for UL transmission on PUSCH, and channel quality feedback (e.g., CSI) for the UL channel.

NR data scheduling can be performed dynamically, e.g., on a per-slot basis. In each slot, the gNB transmits DL control information (DCI) over PDCCH that indicates which RRC CONNECTED UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling. Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant.

As briefly mentioned above, each gNB internally maintains a state (called “CS4LA”) of the UE-specific channel over which PUSCH and PDSCH are transmitted and received. DL CS4LA is based on channel state information (CSI) provided by the UE via CSI reports, including information such as channel quality indicator (CQI), rank indicator (RI), RS received power (RSRP), etc. UL CS4LA is based on channel quality measured on UE transmissions of PUSCH and/or RS (e.g., SRS, DM RS). To account for measurement inaccuracies and the fact that the channel changes over time, the gNB may apply an offset to the estimated CS4LA to obtain an effective CS4LA with less capacity.

For each data packet transmitted via PDSCH or PUSCH, the gNB maps the effect CS4LA to a corresponding modulation and coding scheme (MCS) to be used for the data packet. For DL, the gNB uses the obtained MCS for transmitting the data packet via PDSCH, but also sends the UE an indication of the MCS in the DCI that schedules the data packet. In this manner, the UE is aware of the MCS to use for demodulating and decoding the data packet. For UL, the gNB sends the UE an indication of the MCS in the DCI that schedules the data packet, and the UE uses this MCS for transmitting the data packet via PUSCH.

In either case, the gNB obtains feedback on whether the data packet was successfully received. In the DL, this involves the UE sending hybrid ARQ (HARQ) feedback to the gNB via PUCCH. For the UL, the gNB receiver is aware of its own success or failure of decoding the data packet. If the data packet was successfully received, the gNB will increase the CS4LA by an amount called “step-up”, indicating an increase in channel capacity which may map to a less robust MCS with higher data capacity. If the data packet was not successfully received, the gNB will reduce the CS4LA by an amount called “step-down”, indicating a decrease in channel capacity and a corresponding more robust MCS with less data capacity.

FIG. 4 shows an exemplary step-up/step-down arrangement for estimated CS4LA maintained by the gNB. To maintain a reasonable block (or packet) error rate (BLER) target such as 1%, step-down is typically much larger than step-up, e.g., step-down=100·step-up.

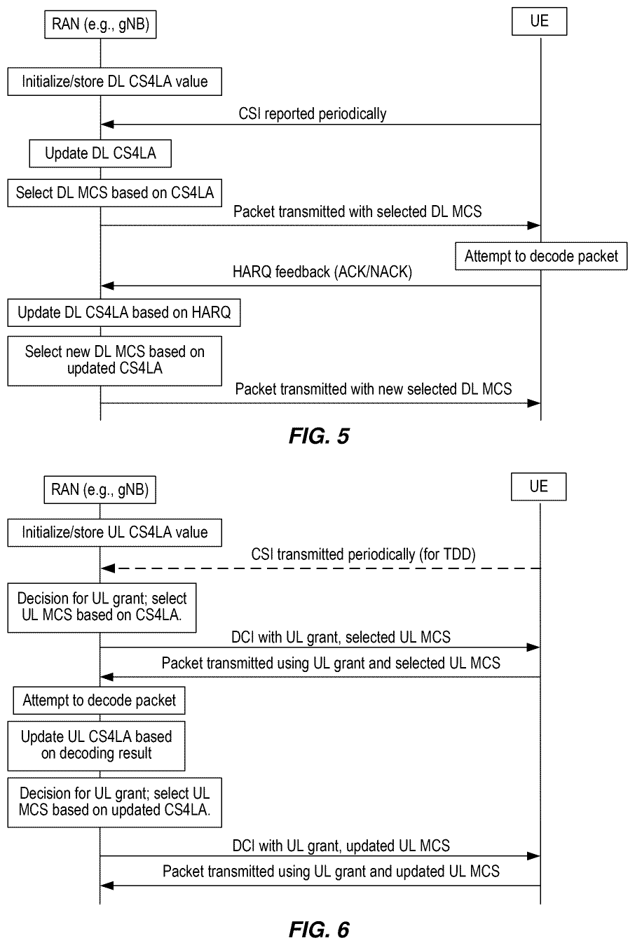

FIG. 5 shows a conventional link adaptation procedure for a DL from a RAN (e.g., a serving gNB) to a UE. Upon setting up a connection with the UE (e.g., in a serving cell), the RAN initializes the DL CS4LA for the UE to an initial value (e.g., default value) and stores it for later access. Also, upon setting up the connection with the RAN in the serving cell, the UE monitors the DL channel and provides CSI reports that include CQI, RI, precoding matrix indicator (PMI), RSRP, etc. The RAN uses these CSI reports to update the DL CS4LA as needed.

At some point, the RAN has DL data or signaling to transmit to the UE via PDSCH. The RAN selects a DL MCS based on the current DL CS4LA for the UE, and uses the selected DL MCS to modulate and encode a packet transmitted to the UE via PDSCH. In some cases, prior to packet transmission, the RAN may transmit a scheduling DCI for the packet on PDCCH; this DCI can include an indication of the selected DL MCS.

Assuming that the UE is aware that the packet is being sent, the UE attempts to demodulate and decode the packet according to the DL MCS and sends HARQ feedback indicating the result. The UE sends an acknowledgement (ACK) if the packet is decoded successfully and a negative ACK (NACK) if the packet is not decoded successfully. The RAN uses this HARQ feedback to update the DL CS4LA. For example, an ACK causes the RAN to increase CS4LA (e.g., by step-up) and a NACK causes the RAN to decrease CS4LA (e.g., by step-down). For a subsequent DL packet transmission to the UE, the RAN selects a new DL MCS based on the updated CS4LA value, and uses the selected DL MCS accordingly.

Similarly, FIG. 6 shows a conventional link adaptation procedure for an UL from a UE to a RAN (e.g., a serving gNB). Upon setting up a connection with the UE (e.g., in a serving cell), the RAN initializes the UL CS4LA for the UE to an initial value (e.g., default value) and stores it for later access. Optionally, upon setting up the connection with the RAN in the serving cell, the UE monitors the DL channel and provides CSI reports that include CQI, RI, precoding matrix indicator (PMI), RSRP, etc. The RAN uses these CSI reports to update the DL CS4LA as needed. The DL monitoring and provision of CSI reports may be useful for TDD channels, where UL and DL are on the same frequency.

Subsequently, the RAN determines that the UE has UL data to transmit, which may be based on a scheduling request (SR) and/or buffer status report (BSR) sent by the UE via PDCCH. The RAN decides to grant the UE UL resources for transmission of the data on PUSCH, and selects an UL MCS based on the current UL CS4LA for the UE. The RAN sends a DCI with the UL grant and an indication of the selected UL MCS, based on which the UE transmits a packet to the RAN via PUSCH.

The RAN attempts to demodulate and decode the received packet according to the UL MCS, and uses the decoding result to update the UL CS4LA accordingly. For example, successful decoding causes the RAN to increase UL CS4LA (e.g., by step-up) and unsuccessful decoding causes the RAN to decrease UL CS4LA (e.g., by step-down). In some variants, the RAN may also update the UL CS4LA based on UL channel quality metrics such as signal-to-interference-and-noise ratio (SINR), RSRP, etc.

Subsequently, the RAN determines that the UE has additional UL data to transmit. The RAN decides to grant the UE UL resources for transmission of the additional data on PUSCH, and selects an UL MCS based on the updated UL CS4LA for the UE. The RAN sends a DCI with the UL grant and an indication of the updated UL MCS, based on which the UE transmits a packet to the RAN via PUSCH.

Although large imbalance between step-up and step-down amounts helps the gNB to maintain transmission performance according to a BLER target, applying the large step-down value may cause a link (e.g., UL or DL) to operate well below actual capacity for an extended duration until many smaller step-up values have been applied. FIG. 7 shows an example scenario that illustrates this issue. The continuous curved line shows the actual channel state while the straight line segments shows the estimated channel state, e.g., CS4LA.

The RAN performs DL transmissions using a DL MCS selected based on the current estimated DL CS4LA, such as illustrated in FIG. 5. The dark-filled circles show instances where the RAN received a NACK for a DL transmission, which causes the RAN to apply a step-down to CS4LA. In contrast, the unfilled circles show instances where the RAN received an ACK for a DL transmission, which causes the RAN to apply a step-up to CS4LA. FIG. 7 illustrates that due to the significantly larger step-down amount, the DL operates for extended periods in which the actual channel state is much better than the estimated channel state used by the RAN for MCS selection. Thus, the MCS used during the extended period is too robust and does not provide as capacity as the channel is capable of handling. In contrast, there is only a small period where the actual channel state is worse than the estimated channel state, which causes the RAN to select an MCS that is not robust enough to meet BLER targets.

Since radio resources are scarce, it is desirable to use as much as possible of actual channel capacity at any given time (e.g., with appropriate MCS), while maintaining BLER performance according to relevant targets. Accordingly, there is a need for techniques for determining the most appropriate MCS at any given time to meet these goals.

Some existing techniques use machine learning (ML) in UE to predict channel quality. Examples of these techniques are described in patent publications WO2022/162152 and KR100988536B1, as well as in U.S. Pat. 11,368,274. Other existing techniques use ML to set link adaptation policy or other relevant parameters. For example, U.S. Pat. Pub. 2022/0182175 describes a technique that sets link adaptation parameters such as target BLER, stepdown, etc. for the duration of a user data session. Even so, this technique is coupled with a conventional link adaptation algorithm that steps down by a large amount and then slowly steps up, with the disadvantages discussed above.

Other existing techniques involve training a ML model in the UE to predict MCS based on DL channel quality measured by the UE, so as to avoid UE CSI feedback and corresponding RAN assignment of MCS based on the UE feedback. An example of these techniques is described in PCT Pub. WO2022/257157.

However, none of these techniques provide link adaptation that enables a RAN and UE to use as much as possible of actual channel capacity at any given time (e.g., with appropriate MCS), while maintaining BLER performance according to relevant targets

Embodiments of the present disclosure address these and related problems, issues, and/or difficulties by a function F(·) that maps available channel state information (e.g., RSRP, CQI, SINR, Beam ID, etc.) corresponding to a set of N slots preceding a particular slot or a set of slots to the likelihood of successful decoding of a packet transmitted during the particular slot or slots via the channel using a given MCS and/or number of PRBs. For example, F(·) can be generated using a supervised learning process with Convolutional Neural Networks (CNNs), Recurrence Neural Networks (RNNs), or the like, to learn about packet reception success/failure based on a temporal series of features extracted from channel state information (CSI). Once this learning or training is completed, F(·) can be used to predict, prior to transmission, the likelihood of a receiver successful decoding of a packet transmitted via a given channel (e.g., according to CSI) using a given MCS and/or number of PRBs. Based on such prediction, the RAN can adjust MCS and/or number of PRBs selected by a conventional link adaptation algorithm as needed to obtain an optimal and/or preferred MCS and/or number of PRBs that have high likelihood of successful decoding as well as data-carrying capacity consistent with the actual channel capacity at the time of transmission.

Embodiments can provide various benefits and/or advantages. For example, embodiments do not require any changes to existing standards, nor any additional signaling between RAN and UE or within the RAN. Furthermore, the ML prediction function F(·) can be used as a plug-in to any existing link adaptation implementation within the RAN, only requiring some relatively small amount of additional baseband processing for ML prediction. Moreover, by proper MCS and/or PRB selection, embodiments can improve a combination of BLER, latency, and data throughput, which can be very useful for certain UEs (e.g., URLLC) that require this combination of performance. In some embodiments, a conventional baseband processor may be too constrained in terms of memory and/or CPU cycles to implement the ML prediction function F(·) and may therefore be supported or scaled up with hardware accelerators and/or cloud computing resources.

As briefly mentioned above, embodiments utilize a ML model, called F(·), to predict, prior to transmission, the likelihood of a receiver successful decoding of a packet transmitted via a given channel using a given MCS. The prediction is based on characteristics of radio channel derived from received channel state information, monitored channel state, and decoding result (e.g., HARQ) of previously transmitted packets. Various embodiments are discussed in more detail below.

In some embodiments, the ML model operates with an existing link adaptation (LA) algorithm in the RAN (e.g., gNB). A candidate MCS and/or a candidate number of PRBs is selected for a packet by the LA algorithm, and the ML model predicts the decoding result for the candidate MCS and/or the candidate number of PRBs using the estimated channel state (e.g., CS4LA). If the ML model predicts likelihood of decoding success below a threshold, a more robust, lower capacity MCS and/or a smaller number of PRBs can be selected instead. This can facilitate meeting very low BLER targets under poor and/or quickly changing channel conditions. For example, a smaller number of PRBs allows the RAN node (or UE) to increase the portion of its transmit power used for each of the PRBs, which can increase received signal-to-interference-and-noise ratio (SINR) at the UE (or RAN node).

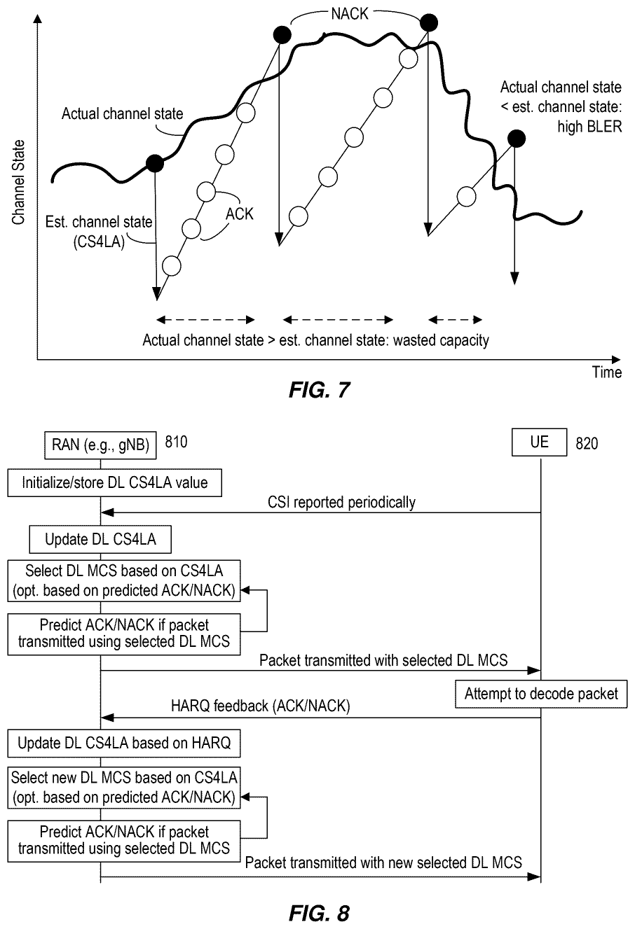

FIG. 8 shows an example link adaptation procedure for a DL from a RAN (810, e.g., a serving gNB) to a UE (820), according to these embodiments. Upon setting up a connection with the UE (e.g., in a serving cell), the RAN initializes the DL CS4LA for the UE to an initial value (e.g., default value) and stores it for later access. Also, upon setting up the connection with the RAN in the serving cell, the UE monitors the DL channel and provides CSI reports that include CQI, RI, PMI, RSRP, etc. The RAN uses these CSI reports to update the DL CS4LA as needed.

At some point, the RAN has DL data or signaling to transmit to the UE via PDSCH. The RAN's LA algorithm selects a candidate DL MCS based on the current DL CS4LA for the UE. The RAN uses the ML model to predict likelihood of decoding success (e.g., ACK or NACK) by the UE for a packet transmitted using the candidate DL MCS selected by the LA algorithm. Put differently, the ML model predicts likelihood of receiving an ACK from the UE based on successful UE decoding of the packet transmitted using the candidate DL MCS.

If NACK is predicted (e.g., based on likelihood of decoding success being less than a threshold), the RAN node can update the candidate MCS to a more robust, lower capacity MCS, for which the ML model predicts decoding success for a transmitted packet. The RAN uses the selected (candidate or updated, as the case may be) DL MCS to modulate and encode a packet transmitted to the UE via PDSCH (e.g., using one or more PRBs). In some cases, prior to packet transmission, the RAN may transmit a scheduling DCI for the packet on PDCCH; this DCI can include an indication of the selected (i.e., candidate or updated) DL MCS.

Assuming that the UE is aware that the packet is being sent, the UE attempts to demodulate and decode the packet according to the DL MCS and sends HARQ feedback indicating the result. For example, the UE sends an ACK if the packet is decoded successfully and a NACK if the packet is not decoded successfully. The RAN uses this HARQ feedback to update the DL CS4LA. For example, an ACK causes the RAN to increase CS4LA (e.g., by step-up) and a NACK causes the RAN to decrease CS4LA (e.g., by step-down).

For a subsequent DL packet transmission to the UE, the RAN's LA algorithm selects a new candidate DL MCS based on the updated CS4LA value. The RAN uses the ML model to predict likelihood of decoding success (e.g., ACK or NACK) for a packet transmitted using the new candidate DL MCS selected by the LA algorithm. If NACK is predicted (e.g., based on likelihood of decoding success being less than the threshold), the RAN node can update the candidate MCS to a more robust, lower capacity MCS, for which the ML model predicts decoding success for a transmitted packet. The RAN uses the selected (candidate or updated, as the case may be) DL MCS to modulate and encode the subsequent packet transmitted to the UE via PDSCH.

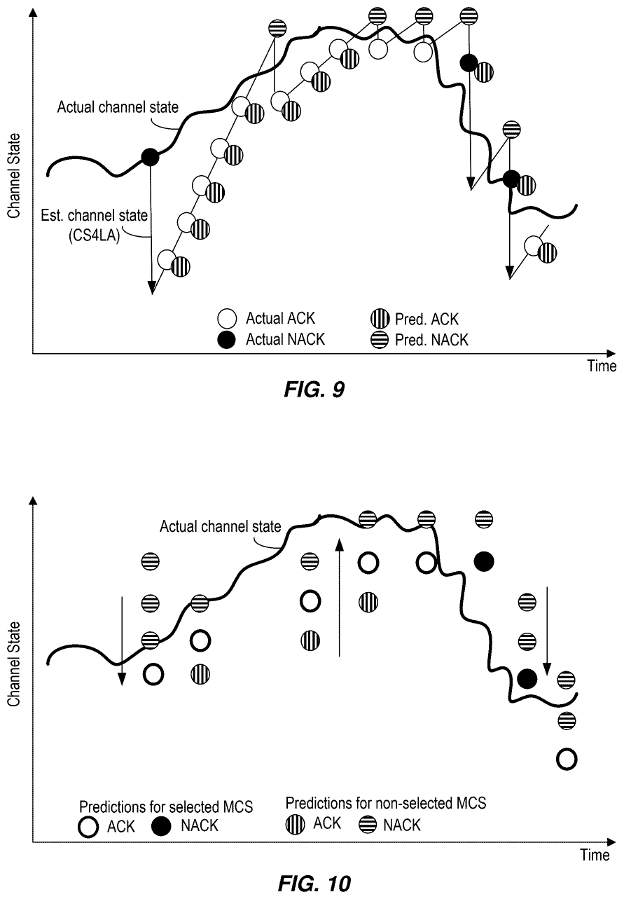

FIG. 9 shows an example scenario that further illustrates these embodiments. Similar to FIG. 7, the continuous curved line shows the actual channel state while the straight line segments shows the estimated channel state, e.g., CS4LA. Also like FIG. 7, the dark-filled circles show instances where the RAN received a NACK for a DL transmission using a given MCS, which causes the RAN to apply a step-down to CS4LA. In contrast, the unfilled circles show instances where the RAN received an ACK for a DL transmission using a given MCS, which causes the RAN to apply a step-up to CS4LA. Also in FIG. 8, the vertically striped circles show instances where the ML model predicted an ACK for a DL transmission using a given MCS, while the horizontally striped circles show instances where the ML model predicted a NACK for a DL transmission using a given MCS.

Initially, the RAN receives a NACK for a DL transmission and applies a step-down to the CS4LA. The ML model predicts an ACK (e.g., based on likelihood of decoding success being at least a threshold) for the next five packets transmitted using MCS selected by the LA algorithm, and the RAN receives ACK's for each of these packets transmitted using the MCS selected by the LA algorithm. The RAN also applies step-ups to CS4LA based on the five received ACK s.

For the seventh packet, the ML model predicts a NACK for the candidate MCS selected by the LA algorithm based on current CS4LA. In this case, the RAN adjusts the candidate MCS to a more robust, lower capacity MCS used for DL transmission of this packet, for which the ML model predicts an ACK and the RAN actually receives an ACK from the UE. This causes the RAN to apply a step-up to the CS4LA. This scenario is repeated for the next two packets.

For packets 10-11, the ML model predicts a NACK for the candidate MCS selected by the LA algorithm based on current CS4LA. For each of these packets, the RAN adjusts the candidate MCS to a more robust, lower capacity MCS used for DL transmission of the packet, for which the ML model predicts an ACK and the RAN actually receives an ACK from the UE. This causes the RAN to apply a step-up to the CS4LA.

For packets 12-13, the ML model predicts a NACK for the candidate MCS selected by the LA algorithm based on current CS4LA. For each of these packets, the RAN adjusts the candidate MCS to a more robust, lower capacity MCS used for DL transmission of the packet, for which the ML model predicts an ACK. However, the RAN actually receives NACK s from the UE for these two packets, causing the RAN to apply step-downs to the CS4LA in both instances. For example, if the ML model predicted an 90% likelihood of receiving an ACK for each of packets 12-13 transmitted using the more robust, lower capacity MCS, there is a corresponding prediction of 10% likelihood of receiving a NACK for each packet-which actually occurred.

For final packet 14, the ML model predicts an ACK for the candidate MCS selected by the LA algorithm, and the RAN actually receives an ACK from the UE in accordance with this prediction.

In other embodiments, the ML model can be used to select an optimal and/or preferred MCS for any given DL transmission, specifically an MCS that meets required BLER while maximizing throughput for current channel quality. FIG. 10 shows an example scenario that further illustrates these embodiments. Similar to FIGS. 7 and 9, the continuous curved line shows the actual channel state. For each of eight packets, FIG. 10 shows predicted decoding success for various candidate MCS that are available to be used. For example, with respect to the first packet, the ML model predicts that three higher capacity (or less robust) candidate MCS will result in NACKs when used for transmission, but that a fourth lower capacity (or more robust) candidate MCS will result in ACK when used for transmission. Accordingly, the RAN selects the fourth candidate MCS and uses it to perform a DL transmission to the UE.

In some variants, the RAN may select the least robust (or highest capacity) candidate MCS that is still predicted to result in an ACK. This is done for packets 2-4 in FIG. 10. In some variants, the RAN may select a candidate MCS that is predicted to result in a NACK. For example, this can be done when none of a set of available MCS are predicted to result in an ACK, such as for packets 6-7 in FIG. 10. In this case, the RAN selects the most robust MCS from the available MCS, even if it is predicted to result in an ACK.

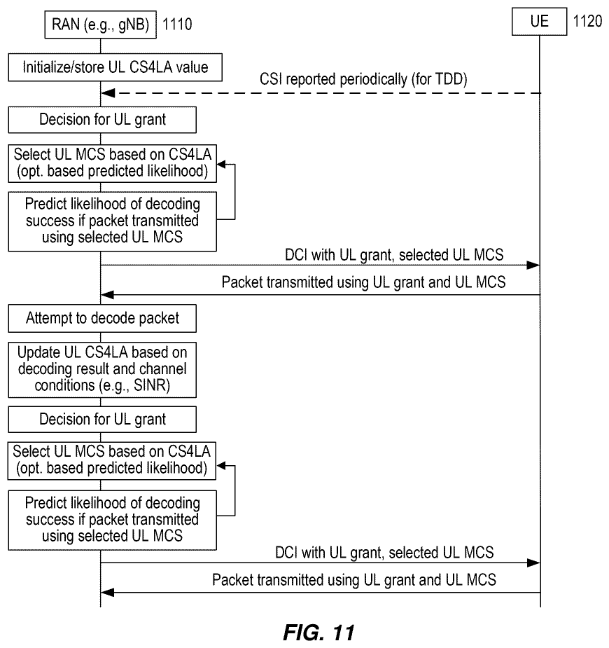

FIG. 11 shows a link adaptation procedure for an UL from a UE (1120) to a RAN (1110, e.g., a serving gNB), according to other embodiments of the present disclosure. Upon setting up a connection with the UE (e.g., in a serving cell), the RAN initializes the UL CS4LA for the UE to an initial value (e.g., default value) and stores it for later access. Optionally, upon setting up the connection with the RAN in the serving cell, the UE monitors the DL channel and provides CSI reports that include CQI, RI, precoding matrix indicator (PMI), RSRP, etc. The RAN uses these CSI reports to update the DL CS4LA as needed. The DL monitoring and provision of CSI reports may be useful for TDD channels, where UL and DL are on the same frequency.

Subsequently, the RAN determines that the UE has UL data to transmit, which may be based on a scheduling request (SR) and/or buffer status report (BSR) sent by the UE via PDCCH. The RAN decides to grant the UE UL resources for transmission of the data on PUSCH, and the RAN's LA algorithm selects a candidate UL MCS based on the current UL CS4LA for the UE. The RAN uses the ML model to predict likelihood of decoding success for a packet transmitted using the candidate UL MCS selected by the LA algorithm.

If the predicted likelihood of decoding success is below a threshold, the RAN node can update the candidate UL MCS to a more robust, lower capacity MCS, for which the ML model predicts a likelihood of decoding success that is at least the threshold. The RAN sends a DCI with the UL grant and an indication of the selected (candidate or updated, as the case may be) UL MCS, based on which the UE transmits a packet to the RAN via PUSCH.

The RAN attempts to demodulate and decode the received packet according to the selected UL MCS, and uses the decoding result to update the UL CS4LA accordingly. For example, successful decoding causes the RAN to increase UL CS4LA (e.g., by step-up) and unsuccessful decoding causes the RAN to decrease UL CS4LA (e.g., by step-down). In some variants, the RAN may also update the UL CS4LA based on UL channel quality metrics such as signal-to-interference-and-noise ratio (SINR), RSRP, etc.

Subsequently, the RAN determines that the UE has additional UL data to transmit. The RAN decides to grant the UE UL resources for transmission of the additional data on PUSCH, and the RAN's LA algorithm selects a candidate UL MCS based on the updated UL CS4LA for the UE. The RAN uses the ML model to predict likelihood of decoding success for a packet transmitted by the UE using the candidate UL MCS selected by the LA algorithm. The RAN can selectively update the candidate UL MCS in accordance with the prediction, as described above. The RAN sends the UE a DCI with the UL grant and an indication of the selected (candidate or updated, as the case may be) UL MCS, based on which the UE transmits a packet to the RAN via PUSCH.

Although embodiments were described above in terms of selecting candidate UL/DL MCS based on UL/DL CS4LA and updating the candidate MCS based on predicted likelihood of decoding success for a packet transmitted using the candidate MCS, in other embodiments the RAN node can select a candidate number of PRBs used to transmit the packet (e.g., based on UL/DL CS4LA) and updating the candidate number of PRBs based on predicted likelihood of decoding success for a packet transmitted using the candidate number of PRBs.

For example, the RAN node can update the candidate number of PRBs to a smaller number when predicted likelihood of decoding success is below the threshold. In particular, a smaller number of PRBs allows the RAN node (or UE) to increase the portion of its transmit power used for each of the PRBs, which can increase received SINR at the UE (or RAN node) and, consequently, likelihood of decoding success.

Moreover, these different embodiments can also be used in combination. For example, if the RAN node starts with a candidate MCS and a candidate number of PRBs, it can update the candidate number of PRBs to a smaller number and/or the candidate MCS to a more robust and/or lower capacity MCS when predicted likelihood of decoding success is below the threshold.

In some embodiments, the RAN node can begin with a plurality of different combinations of candidate MCS and candidate number of PRBs, such that each combination differs from all other combinations in terms of number of PRBs and/or MCS. When the predicted likelihood of decoding success is at least a threshold for at least one of the combinations, the RAN node may select the least robust and/or highest capacity combination for which the predicted likelihood of decoding success is at least the threshold. Otherwise, when the predicted likelihood of decoding success is less than the threshold for all of the combinations, the RAN node may select the most robust and/or lowest capacity combination.

The function F(·) described above can be generated by a machine learning (ML) process such as supervised learning, reinforcement learning, or unsupervised learning. For example, supervised learning can be performed offline by collecting logs and/or system traces and learning the function F(·) from the collected logs. Alternatively, supervised learning can be performed online during continuous operation of the RAN, based on each PDSCH transmission performed and/or each PUSCH transmission received. In this manner, the function F(·) can be continuously refined in accordance with current channel conditions.

Supervised learning can be done in various ways including random forests, support vector machines, deep neural networks (DNNs), convolutional neural networks (CNNs), and recurrent neural networks (RNNs). One advantage of DNNs is that they involve simple vector-matrix multiplications, which have a relatively low complexity of implementation in hardware.

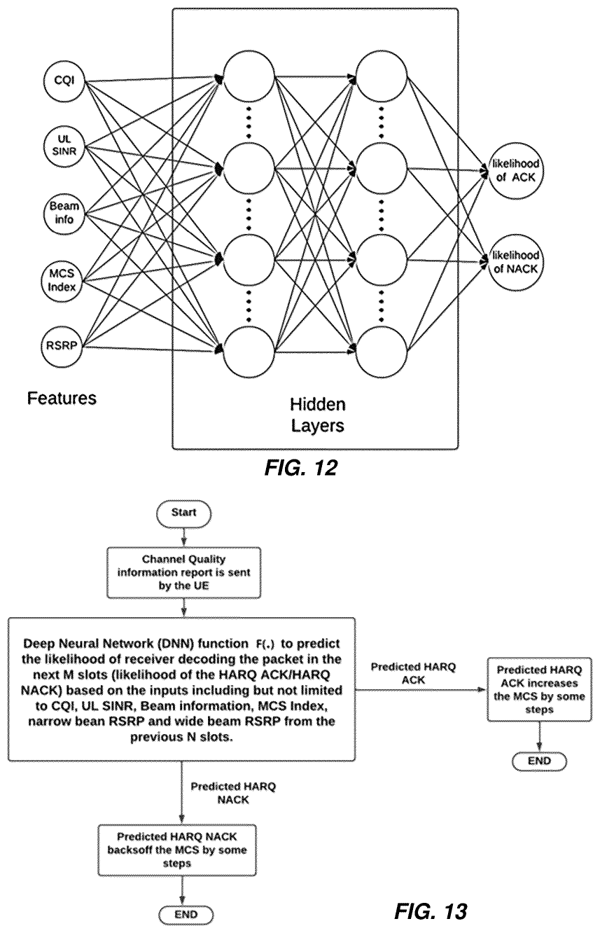

FIG. 12 shows a simplified RNN structure according to some embodiments of the present disclosure. Features that are extracted from the channel characteristics (e.g. CQI, RSRP, etc. received from UE and/or features computed by a network node such as UL-SINR, etc.) are fed into the RNN input layer and then processed by a set of recurrent layers, with two recurrent layers shown as an example. The extracted features may include a plurality of similar sets of features, each set corresponding to a different slot preceding a particular slot of interest. Finally, the output of the recurrent layers is fed to an output layer that produces a likelihood of ACK (or successful decoding) and a likelihood of NACK (or unsuccessful decoding).

FIG. 13 shows a flowchart for how an RNN can be used in some embodiments of the present disclosure. In this example, the UE provides a CQI report to the RAN. Subsequently, the RNN predicts the likelihood of a receiver decoding a PDSCH transmission in a particular slot or set of slots (e.g., M slots). The prediction can be based on the UE's CQI report as well as other information such as measured UL SINR, beam information, MCS index, RSRP, etc, from a plurality (e.g., N) slots preceding the particular slot or set of slots. In FIG. 13, this prediction is shown as a predicted HARQ ACK or NACK. Based on this prediction, the receiver selects a more robust (for predicted NACK) or less robust (for predicted ACK) MCS to use for an actual PDSCH transmission.

Supervised NN training starts by defining the NN inputs (called “features”) and the NN outputs (called “labels”). A RNN should be trained with a large collection of samples to accurately extract the likelihood values. If not trained properly, overfitting or underfitting can occur. Overfitting occurs when the RNN memorizes the structure of the preambles from training but is unable to generalize to unseen preamble characteristics. In contrast, underfitting occurs when the DNN is unable to learn a correct function even from the training data. To prevent overfitting or underfitting, a set of well-engineered features must be extracted from the preamble characteristics.

The following matrix L shows an exemplary collection of N log samples of channel characteristics corresponding to N instances of HARQ feedback:

$$L = [ \begin{matrix}{CQI}_{1} … {CQI}_{N} \\ {SINR}_{1}^{L 1} … {SINR}_{N}^{L 1} \\ {SINR}_{1}^{L 2} … {SINR}_{N}^{L 2} \\ {B}_{1}^{SINR} … {B}_{N}^{SINR} \\ {W}_{1}^{SINR} … {W}_{N}^{SINR} \\ {MCS}_{1} … {MCS}_{N} \\ {WB}_{1} … {WB}_{N} \\ {NB}_{1} … {NB}_{N} \\ {RSRP}_{i}^{WB} … {RSRP}_{N}^{WB} \\ {RSRP}_{i}^{NB} … {RSRP}_{N}^{NB} \\ {D}_{{RSRP}_{1}} … {D}_{{RSRP}_{N}} \\ {y}_{1} … {y}_{N}\end{matrix} ]$$

where for each i=1 . . . N:
CQIᵢ is channel quality indicator reported by the UE,
SINR_{L1}_{ᵢ} is the UL received signal-to-interference-plus noise ratio for layer 1 in units of dB,
SINR_{L2}_{ᵢ} is the UL received signal-to-interference-plus noise ratio for layer 2 in units of dB,
B_{SINR}_{ᵢ} is the best signal-to-interference-plus noise ratio between the two layers in units of dB,
W_{SINR}_{ᵢ} is the best signal-to-interference-plus noise ratio between the two layers in units of dB,
MCSᵢ is the modulation and coding scheme selected by the link adaptation algorithm,
Bᵢ^{WB} is the integer-valued wide beam index of the serving wide beam,
NBᵢ is the integer-valued narrow beam index,
WBᵢ is the integer-valued narrow beam index of the serving narrow beam,.
RSRP
i^{WB} is the wide beam reference signal received power of the serving wide beam in units of dBm,
RSRPᵢ^{NB} is the narrow beam reference signal received power in units of dBm,.
D_{RSRP}_{ᵢ} is the difference between the narrow beam and wide beam reference signal received power in units of dBm, and
yᵢ∈{0,1} is the HARQ feedback received for slot i.

However, the above list is not exclusive. For example, alternative inputs can include:
channel timing adjustment,
latest HARQ feedback,
signal-to-interference-plus noise ratio difference between layer 1 and layer 2 in units of dBm (D_{SINR}_{ᵢ})
an integer-valued wide beam index of the serving wide beam (B_{swi}),
an integer-valued wide beam index of the neighbor wide beam x (1 . . . j) (B_{nwi}^{x}),
an integer-valued narrow beam index of the serving narrow beam (Bₛₙᵢ),
an integer-valued narrow beam index for the neighbor narrow beam y (1 . . . k) (Bₙₙᵢ^{y})
a wide beam reference signal received power of the serving wide beam in units of dBm (RSRP_{swi}),
a narrow beam reference signal received power in units of dBm (RSRP_{nwi}),
a wide beam reference signal received power of the neighbor wide beam x (1 . . . j) in units of dBm (RSRP_{nwi}^{x}),
a narrow beam reference signal received power of the neighbor narrow beam y (1 . . . k) in units of dBm (RSRPₙₙᵢ^{xy}), and
information carrying capacity (ICC).

For DL, ICC can be determined based on a mapping from the CSI report and then updated based on the ACK/NACK received from the UE. For the UL, ICC is generally based on UL SINR measurement and with possible updates based on other measurements (e.g., SRS, DM RS, etc.) and/or based on decoding result. CS4LA discussed elsewhere herein can be considered a type of ICC.

Based on these log samples, an exemplary set of features for J timesteps {Fᵢ∈R^{t×100}}, ∀i=J+1, . . . , N for sample index i is as follows:

$${F}^{i} = [ {L}_{1 - J + 1} , … , {\hat{L}}_{i} ] ,$$

where Lᵢ₋ⱼ₊₁∈e¹¹ is the (i−J+1)th column of the matrix L, and \hat{L}ᵢ is the modified ith column of the matrix where the last index corresponding to the HARQ feedback is set to 0, i.e., [\hat{L}ᵢ]₁₁=0.

In some embodiments, a DNN may include an input layer, an RNN layer containing h hidden states and K outputs, two fully connected hidden layers, and an output layer. The recurrent units have their own set of weights Wᵣₙₙ∈R^{h×h},U∈R^{h}, V∈R^{h×K} and set of biases bᵣₙₙ∈R^{h}, Cᵣₙₙ∈R^{K}. Using these weights and biases, the input output relationship of a single RNN unit for timestep t can be expressed as:

$$\begin{matrix}{H}^{t} = {σ}_{r 1} ( {b}_{rnn} + {H}^{t - 1} {W}_{rnn} + {F}^{t} {U}^{t} ) \\ {0}^{t} = {σ}_{r 2} ( {c}_{rnn} + {H}^{t} {V}^{t} )\end{matrix}$$

where F^{t} is the features at the timestep t, σᵣ₁(·) is the activation function of the hidden state H^{t}∈R^{h}, and σᵣ₂(·) is the activation function for the RNN layer output O^{t}∈R^{K}.

For the fully connected layers, each layer j may have its own weights Wⱼ∈R^{z×q} and biases bⱼ∈R^{q} where z is the number of inputs and q is the number of outputs, i.e., number of neurons. Using these weights and biases, the input output relationship of a layer can be expressed as:

$${o}_{j} = {σ}_{j} ( {W}_{j} \times {x}_{j} + {b}_{j} ) ,$$

where σⱼ(·) is the activation function of the layer j, which can be a non-linear function. An exemplary activation function for the two hidden layers is rectified linear input, defined as:

$$ReLU ( x ) = \{ \begin{matrix}x , x > 0 \\ 0 , x \leq 0\end{matrix} .$$

Similarly, an exemplary activation function to output a likelihood value is the SoftMax function, which is defined as follows:

$$softmax ( {x}_{i} ) = \frac{{x}_{i}}{{\sum }_{c = 1}^{C} {e}^{{x}_{c}}} ,$$

where C is the number of outcomes, such as number of classes for a supervised classification task.

Finally, the overall input-output relationship for the exemplary RNN is given in equation (1) below:

$${\hat{y}}_{i} = softmax ( {W}_{3} ( ReLU ) {W}_{2} \times ( ReLU ( {W}_{1} \times {f}_{1} + {b}_{1} ) + {b}_{2} ) + {b}_{3} ) ) ,$$

where Oₑ∈R^{jk} contains the vectorized RNN layer outputs for all J timesteps and K RNN units and where ŷᵢ is the output of the DNN for sample index i.

With the log samples stored in L and the corresponding HARQ feedback stored in Y=[y₁ . . . , y_{N}], the weights and the biases described above can be calculated by minimizing the cross-entropy loss between the DNN output and the ground truth labels:

$$arg {min}_{} {\sum }_{i}^{N} - {\sum }_{j}^{C} {y}_{i}^{j} * log ( {\hat{y}}_{i}^{j} ) ,$$

where set [symbol] contains weights and biases for all layers, and each y is a one hot-encoded vector such that yᵢ∈{0,1}^{C}, Σⱼ₌₁^{C}yᵢ^{j}=1 with C=2. In other words, yᵢ=[1, 0] if the label is NACK and [0,1] if the label is ACK. Typically, this optimization problem does not have a closed-form solution but can be solved by numerical techniques such as stochastic gradient descent, described by S. Amari, Backpropagation and stochastic gradient descent method, Neurocomputing, vol. 5 pages 185-196, June 1993.

After the weights and biases are calculated during training, the RNN can be used for inference. In this operation, inputting new feature vectors fᵢ generated from current channel characteristics Li produces a set of outputs of likelihood of HARQ ACK and NACK, such as illustrated in FIG. 12.

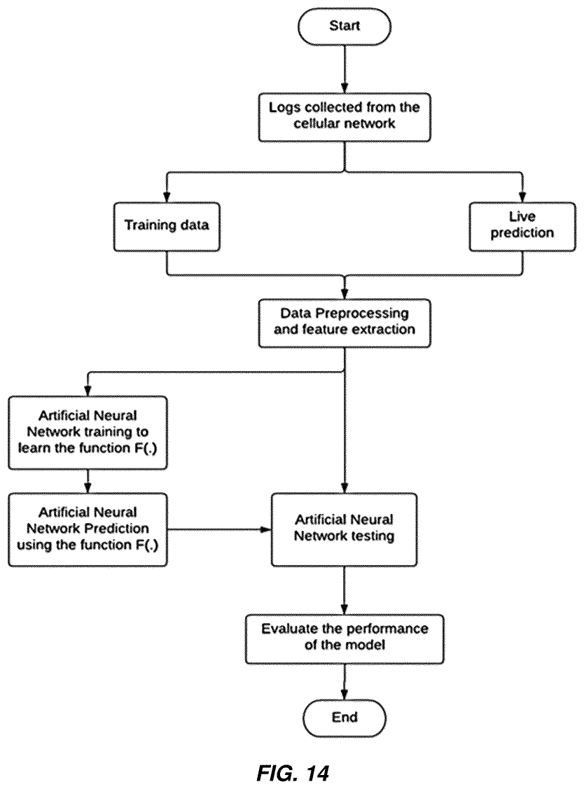

An exemplary test scenario was used to evaluate the predictive performance of various embodiments, with FIG. 14 showing a flow diagram of the evaluation procedure used. Specifically, a set of gated recurrent units (GRUs) connected to a set of fully connected layers was used. These networks serve specific purposes and are instrumental in enhancing the methodology's performance. The set of GRUs may include a first GRU layer equipped with 64 recurrent units and a second GRU layer with 45 recurrent units. These GRU layers efficiently process the sequential data and capture the temporal dependencies using a feedback loop system, facilitating the repeated circulation of data through the same nodes. In an embodiment, two fully connected layers with 50 neurons each follow the GRU RNN layers. These neurons employ Rectified Linear Unit (ReLU) activation, which introduces non-linearity and enhances the model's feature extraction capabilities. In an embodiment, the RNN's output layer includes 2 neurons utilizing SoftMax activation. This enables probabilistic classification, especially suitable for binary decisions such as ACK/NACK labeling.

Skilled persons will recognize that other activation functions can be used in the various layers. For example, sigmoid or linear activation functions may alternately be used in the output layer. As another example, Gaussian error linear unit (GELU), exponential linear unit (ELU), scaled ELU (SELU), or sigmoid linear unit (SiLU) activation functions may alternately be used in the hidden layers.

First, samples of channel characteristic parameters and corresponding ACK/NACK results (or labels) were collected from an over the air (OTA) mobility test on a route with the following four sections:
Section A: 0 km-0.6 km with pathloss increase from 93 dB to 135 dB
Section B: 0.6 km-0.9 km with pathloss mean at 137.73 dB.
Section C: 0.9 km-1.0 km where pathloss varies as the environment changes.
Section D: 1.0 km-1.2 km with pathloss up to 145 dB at 1.2 km.

The radio channel was in NR frequency range 2 (FR2), which covers 24.25 to 71.0 GHz. Approximately 665,000 samples were collected.

Subsequently, the samples were separated into training data and testing data for live prediction. The training data consisted of approximately 465,000 samples (˜70%) while the testing data consisted of approximately 200,000 samples (˜30%). For this evaluation, the samples were also separated by cells covering the test route, such that each cell had training data and testing data independent of other cells.

Next, preprocessing is performed to extract the input features from the channel characteristic parameters, such as described above, enabling the model to work with transformed representations of the raw data, and the RNN is trained using the features and the ACK/NACK labels from the training data. In particular, the RNN was trained by using the Adam optimizer described by D. Kingma & J. Ba, Adam: A method for stochastic optimization, Proc. 3rd Int'l Conf. for Learning Representations, 2015. Moreover, a separate RNN was trained for each of the cells based on the cell-specific training samples.

After the cell-specific RNNs were trained, they were used for real-time predictions by employing the same feature extraction steps. Each RNN's inference or prediction performance was evaluated by comparing the predicted ACK/NACK values (or labels) and corresponding actual (or ground-truth) ACK/NACK labels in the testing dataset ensuring the accuracy and effectiveness of the network.

Some results for this test scenario are described below. Because the SoftMax output values are in the range 0-1 and the ground-truth labels are either zero (NACK) or one (ACK), a quantization operation can be used to calculate the accuracy of the NN predictions, as follows:

$$accuracy = 1 - \frac{{\sum }_{i = 1}^{N} \vert Q ( {\hat{y}}_{i} , t ) - {y}_{i} \vert}{N} ,$$

where

$$Q ( x , t ) = \{ \begin{matrix}1 , & x > t \\ 0 , & x \leq t\end{matrix}$$

is the quantization function based on a threshold, t. In addition to accuracy, the following metrics are used to evaluate the performance:
True positive rate (TPR): The ratio of correctly classified labels among all positive (ACK) labels defined as

$$TPR = \frac{TP}{P} ,$$

where TP is the number of correctly classified positive labels, and P is the total number of positive labels in the data. In other words, both actual and predicted decoding results are ACK, which results in no performance improvement.
True negative rate (TNR): The ratio of correctly classified labels among all negative (NACK) labels defined as

$$TPR = \frac{TN}{N} ,$$

where TN is the number of correctly classified negative labels, and N is the total number of negative labels in the data. In other words, both actual and predicted decoding results are NACK, based on which embodiments can provide some advantages in terms of reduced BLER and latency, as well as increased throughput.
False positive rate (FPR): The ratio of incorrectly classified negative labels among all negative (NACK) labels defined as

$$FPR = \frac{FP}{N} ,$$

where FP is the number of incorrectly classified negative labels, and N is the total number of negative labels in the data. In other words, the predicted result was an ACK but the actual result was a NACK. Such false positives can increase BLER and latency and decrease throughput, thereby offsetting some of the advantages of true negative prediction.
False negative rate (FNR): The ratio of incorrectly classified positive labels among all negative (NACK) labels defined as

$$FNR = \frac{FN}{P} ,$$

where FN is the number of incorrectly classified positive labels, and P is the total number of negative labels in the data. In other words, the predicted result was a NACK but the actual result was an ACK. Such false negatives have no effect on BLER and latency but decrease throughput due to selection of lower MCS, thereby offsetting some of the advantages of true negative prediction.

Intuitively, one important aspect is minimizing FPR since it is highly correlated to BLER. Put differently, false positive predictions will result in NACKs, thereby increasing BLER and latency. Another important aspect is maximizing TNR since it is highly correlated with a reduction in retransmissions. Put differently, true negative predictions will cause selection of more robust MCS that results in ACK s that do not require retransmissions.

Furthermore, these metrics can be arranged in a so-called “confusion matrix”, C∈R^{2×2}, which is given by:

$$C = [ \begin{matrix}TNR & FPR \\ FNR & TPR\end{matrix} ]$$

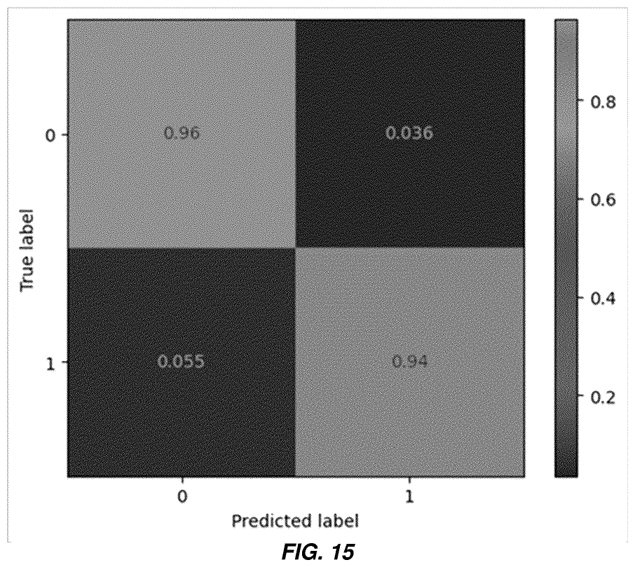

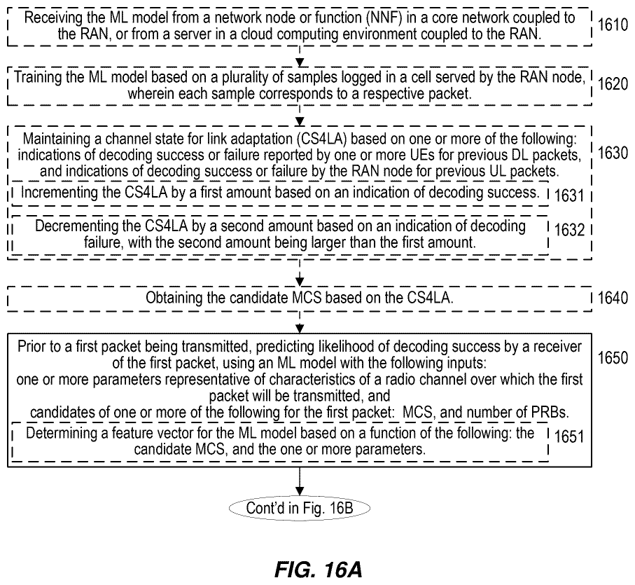

FIG. 15 shows a graph of a confusion matrix for a set of test samples having an initial BLER of 32%. This result is based on an assumption that all true negative samples are transmitted with a more robust MCS that can be successfully decoded by the UE or RAN receiver. The following metrics illustrate improved performance of embodiments of the present disclosure relative to conventional LA algorithm:
BLER: Decreased from 32% to 1%;
Re-transmissions: Decreased by 96%; and
Throughput: Increased by 19.4%.

The FPR of 0.036 in the upper right-hand quadrant of FIG. 15 directly correlates with the reduction in BLER from 32% to 1%. The actual BLER can also be adjusted up or down by the underlying LA algorithm using a more or less robust MCS for a given BLER target. The TNR of 0.96 in the upper left quadrant of FIG. 15 directly correlates with the 96% decrease in retransmissions, assuming NACK prediction causes selection of a more robust MCS that facilitates decoding.

The FNR of 0.055 in the lower left quadrant of FIG. 15 does not increase BLER, since (false) NACK prediction results in a more robust MCS that facilitates decoding. However, a more robust MCS will also have lower capacity, causing a reduction in throughput. Assuming data capacity is reduced by half for the false negatives, when combined with the 96% reduction in retransmissions for true negatives, this results in an overall throughput increase of 19.4%.

The training and inference procedures for the ML model corresponding to the function F(·) can be implemented or performed by the same entity or by different entities, according to various embodiments. For example, if the function F(·) is cell-specific as discussed above, the training can be performed by the RAN node serving each cell, by a node or function in the core network (e.g., NWDAF), or by a common training function in a cloud RAN environment such as Open RAN (O-RAN). Likewise, the inference function can be performed by the RAN node serving each cell, by a node or function in the core network (e.g., NWDAF), or by a common inference function in a cloud RAN environment such as O-RAN. However, having the RAN node perform inference may be advantageous since that result can be used by the RAN node's LA algorithm for adjusting MCS selections.

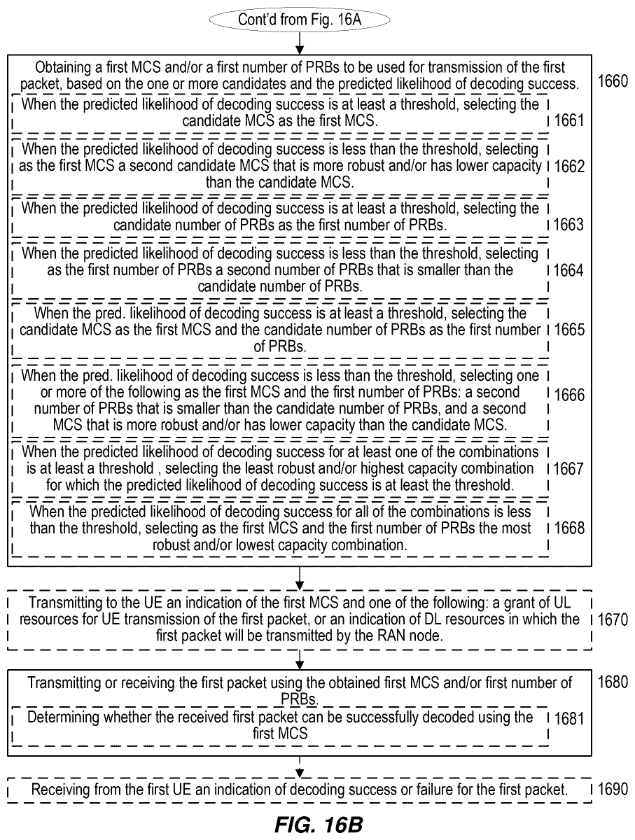

Various features of the embodiments described above correspond to various operations illustrated in FIG. 16, which show an exemplary method (e.g., procedure) for a RAN node. In other words, various features of the operations described below correspond to various embodiments described above. Although FIG. 16 show specific blocks in a particular order, the operations of the exemplary methods can be performed in different orders than shown and can be combined and/or divided into blocks having different functionality than shown. Optional blocks or operations are indicated by dashed lines.

In particular, FIG. 16 (which includes FIGS. 16A and 16B) shows an exemplary method (e.g., procedure) performed by a RAN node for communication with one or more UEs, according to various embodiments of the present disclosure. The exemplary method can be performed by a RAN node (e.g., base station, gNB, etc.) or portion thereof (e.g., DU), such as described elsewhere herein.

The exemplary method includes the operations of block 1650, where prior to a first packet being transmitted, the RAN node predicts likelihood of decoding success by a receiver of the first packet, using an ML model with the following inputs:
one or more parameters representative of characteristics of a radio channel over which the first packet will be transmitted, and
candidates of one or more of the following for the first packet: modulation and coding scheme (MCS), and number of physical resource blocks (PRBs);

In one embodiment, the one or more parameters represent characteristics of the radio channel during a plurality of regularly spaced time periods (e.g., slots) preceding the transmission of the first packet. The exemplary method also includes the operations of block 1660, where the RAN node obtains a first MCS and/or a first number of PRBs to be used for transmission of the first packet, based on the one or more candidates and the predicted likelihood of decoding success. The exemplary method also includes the operations of block 1680, where the RAN node transmits or receives the first packet using the obtained first MCS and/or first number of PRBs.

In some embodiments, the first packet is a DL packet transmitted by the RAN node to a first UE using the first MCS. In such case, the exemplary method also includes the operations of block 1690, where the RAN node receives from the first UE an indication of decoding success or failure for the first packet. In particular, the indication received from the UE is one of the following: a hybrid ARQ (HARQ) acknowledgement (ACK) indicating decoding success, or a HARQ negative ACK (NACK) indicating decoding failure.

In other embodiments, the first packet is an UL packet received by the RAN node from the first UE using the first MCS and receiving the first packet in block 1680 includes the operations of sub-block 1681, where the RAN node determines whether the received first packet can be successfully decoded using the first MCS.

In some embodiments, the exemplary method also includes the operations of block 1670, where before transmitting or receiving the first packet in block 1680, the RAN node transmits to the UE an indication of the first MCS and one of the following: a grant of UL resources for UE transmission of the first packet, or an indication of DL resources in which the first packet will be transmitted by the RAN node.

In some embodiments, obtaining the first MCS in block 1660 includes the following operations, labelled with corresponding sub-block numbers:
(1661) when the predicted likelihood of decoding success is at least a threshold, selecting the candidate MCS as the first MCS; and
(1662) when the predicted likelihood of decoding success is less than the threshold, selecting as the first MCS a second candidate MCS that is more robust and/or has lower capacity than the candidate MCS.
   FIGS. 8-9 show an example of these embodiments.

In other embodiments, obtaining the first MCS in block 1660 includes the following operations, labelled with corresponding sub-block numbers:
(1663) when the predicted likelihood of decoding success is at least a threshold, selecting the candidate number of PRBs as the first number of PRBs; and
(1664) when the predicted likelihood of decoding success is less than the threshold, selecting as the first number of PRBs a second number of PRBs that is smaller than the candidate number of PRBs.

In other embodiments, obtaining the first MCS in block 1660 includes the following operations, labelled with corresponding sub-block numbers:
(1665) when the predicted likelihood of decoding success is at least a threshold, selecting the candidate MCS as the first MCS and the candidate number of PRBs as the first number of PRBs; and.
(1666) when the predicted likelihood of decoding success is less than the threshold, selecting one or more of the following as the first MCS and the first number of PRBs: a second number of PRBs that is smaller than the candidate number of PRBs, and a second MCS that is more robust and/or has lower capacity than the candidate MCS.

In other embodiments, predicting likelihood of decoding success for the first packet using the ML model is performed in block 1650 for a plurality of different combinations of candidate MCS and candidate number of PRBs. In such embodiments, obtaining the first MCS in block 1660 includes the following operations, labelled with corresponding sub-block numbers:
(1667) when the predicted likelihood of decoding success is at least a threshold for at least one of the combinations, selecting as the first MCS and the first number of PRBs the least robust and/or highest capacity combination for which the predicted likelihood of decoding success is at least the threshold; and
(1668) when the predicted likelihood of decoding success is less than the threshold for all of the combinations, selecting as the first MCS and the first number of PRBs the most robust and/or lowest capacity combination.
   FIG. 10 shows an example of these embodiments.

In some embodiments, the parameters representative of characteristics of the radio channel include one or more of the following:
UL SINR measured by the RAN node;
DL channel state information (CSI) reported by the one or more UEs;
an index associated with a beam used to communicate with the UE;
indications of decoding success or failure reported by the one or more UEs for DL packets previously transmitted by the RAN node;
indications of decoding success or failure by the RAN node for UL packets previously transmitted by the one or more UEs; and
timing adjustments for UL packets previously transmitted by the one or more UEs.

In some of these embodiments, the exemplary method can also include the following operations, labelled with corresponding block numbers:
(1630) maintaining a channel state for link adaptation (CS4LA) based on one or more of the following: the indications of decoding success or failure reported by the one or more UEs for the DL packets, and the indications of decoding success or failure by the RAN node for the UL packets; and.
(1640) obtaining the candidate MCS based on the CS4LA.

In some variants of these embodiments, maintaining the CS4LA in block 1630 includes the following operations, labelled with corresponding sub-block numbers:
(1631) incrementing the CS4LA by a first amount based on an indication of decoding success; and
(1632) decrementing the CS4LA by a second amount based on an indication of decoding failure, with the second amount being larger than the first amount.

In some further variants, when the predicted likelihood of decoding success for the first packet using the candidate MCS is less than a threshold, the obtained first MCS is less robust and/or has higher capacity than a further candidate MCS obtained based on the CS4LA decremented by the second amount.

In some of these embodiments, the DL CSI reported by the one or more UEs includes one or more of the following: channel quality indicator (CQI), reference signal received power (RSRP), rank indicator (RI), and pre-coding matrix indicator (PMI).

In some embodiments, the ML model is a recurrence neural network (RNN) comprising an input layer configured to receive input, an output layer configured to output a predicted likelihood of decoding success by a receiver of the first packet, and two or more hidden layers intermediate between the input layer and the output layer. The hidden layers may be fully connected. FIG. 12 shows an example of these embodiments.

In some of these embodiments, each of the hidden layers is configured to generate a plurality of outputs based on respective first activation functions. For example, each first activation function can be rectified linear unit (ReLU), Gaussian error linear unit (GELU), exponential linear unit (ELU), scaled ELU (SELU), or sigmoid linear unit (SiLU). Also, the predicted likelihood of decoding success is generated by the output layer based on the outputs of one of the hidden layers and one or more second activation functions. For example, each second activation function can be SoftMax, sigmoid, or linear.

In some of these embodiments, the input to the input layer is a feature vector and predicting likelihood of decoding success by a receiver of the first packet using the ML model in block 1650 includes the operations of sub-block 1651, where the RAN node determines the feature vector based on a function of the following: the candidate MCS for the first packet, and the one or more parameters representative of characteristics of the radio channel over which the first packet will be transmitted. The one or more parameters may be representative of the radio channel characteristics during a plurality of regularly spaced time periods preceding the transmission of the first packet. In some variants, the function is identity, such that the feature vector contains the candidate MCS for the first packet and the one or more parameters representative of characteristics of the radio channel over which the first packet will be transmitted. An example of these variants was discussed above.

In some embodiments, the ML model is specific to a cell by which the RAN node serves the one or more UEs. In other embodiments, the ML model is common to a plurality of cells in the RAN, including the cell by which the RAN node serves the UE.

In some embodiments, the exemplary method also includes the operations of block 1620, where the RAN node trains the ML model based on a plurality of samples logged in a cell served by the RAN node. Each sample corresponds to a respective packet and includes the following:
an MCS used for transmission of the packet,
an indication of decoding success or failure by a receiver of the packet, and
one or more parameters representative of characteristics of a radio channel over which the packet was transmitted, wherein the parameter(s) or characteristics may be measured during a plurality of regularly spaced time periods preceding the transmission of the first packet.

In other embodiments, the exemplary method also includes the operations of block 1610, where the RAN node receives the ML model from a network node or function (NNF) in a core network coupled to the RAN, or from a server in a cloud computing environment coupled to the RAN. In such embodiments, the received ML model has been trained on plurality of samples logged in a cell served by the RAN node, and each sample corresponds to a respective packet and includes the following:
an MCS used for transmission of the packet,
an indication of decoding success or failure by a receiver of the packet, and
one or more parameters representative of characteristics of a radio channel over which the packet was transmitted.

In some of these embodiments, the ML model is trained (e.g., by the RAN node in block 1620 or by the NNF before being received by the RAN node in block 1610) based on one of the following processes: supervised learning, unsupervised learning, or reinforcement learning.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

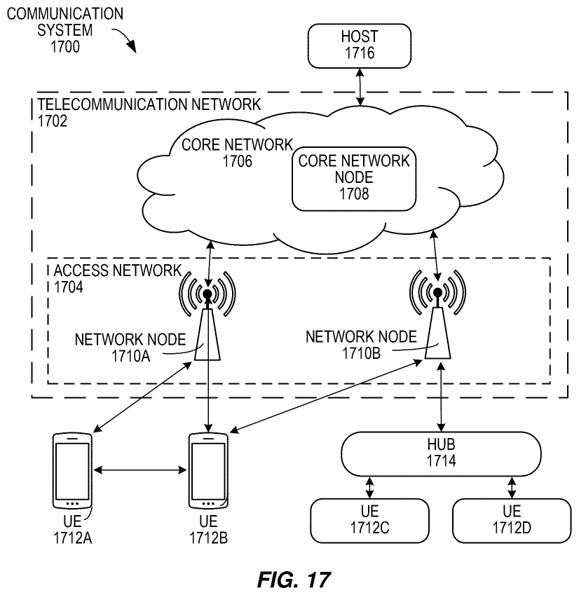

FIG. 17 shows an example of a communication system 1700 in accordance with some embodiments. In this example, communication system 1700 includes a telecommunication network 1702 that includes an access network 1704 (e.g., RAN) and a core network 1706, which includes one or more core network nodes 1708. Access network 1704 includes one or more access network nodes, such as network nodes 1710a-b (one or more of which may be generally referred to as network nodes 1710), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 1702 includes one or more Open-RAN (ORAN) network nodes. An ORAN network node is a node in telecommunication network 1702 that supports an ORAN specification (e.g., a specification published by the O-RAN Alliance, or any similar organization) and may operate alone or together with other nodes to implement one or more functionalities of any node in telecommunication network 1702, including one or more network nodes 1710 and/or core network nodes 1708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 1710 facilitate direct or indirect connection of UEs, such as by connecting UEs 1712a-d (one or more of which may be generally referred to as UEs 1712) to core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1700 may include any number of wired or wireless networks, network nodes, UEs, and/or any other components or systems that may facilitate or participate in the communication of data and/or signals whether via wired or wireless connections. Communication system 1700 may include and/or interface with any type of communication, telecommunication, data, cellular, radio network, and/or other similar type of system.

UEs 1712 may be any of a wide variety of communication devices, including wireless devices arranged, configured, and/or operable to communicate wirelessly with network nodes 1710 and other communication devices. Similarly, network nodes 1710 are arranged, capable, configured, and/or operable to communicate directly or indirectly with UEs 1712 and/or with other network nodes or equipment in telecommunication network 1702 to enable and/or provide network access, such as wireless network access, and/or to perform other functions, such as administration in telecommunication network 1702.

In the depicted example, core network 1706 connects network nodes 1710 to one or more hosts, such as host 1716. These connections may be direct or indirect via one or more intermediary networks or devices. In other examples, network nodes may be directly coupled to hosts. Core network 1706 includes one or more core network nodes (e.g., 1708) that are structured with hardware and software components. Features of these components may be substantially similar to those described with respect to the UEs, network nodes, and/or hosts, such that the descriptions thereof are generally applicable to the corresponding components of core network node 1708. Example core network nodes include functions of one or more of a Mobile Switching Center (MSC), Mobility Management Entity (MME), Home Subscriber Server (HSS), Access and Mobility Management Function (AMF), Session Management Function (SM F), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1716 may be under the ownership or control of a service provider other than an operator or provider of access network 1704 and/or telecommunication network 1702, and may be operated by the service provider or on behalf of the service provider. Host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1702 is a cellular network that implements 3GPP standardized features. Accordingly, telecommunication network 1702 may support network slicing to provide different logical networks to different devices that are connected to telecommunication network 1702. For example, telecommunication network 1702 may provide Ultra Reliable Low Latency Communication (URLLC) services to some UEs, while providing Enhanced Mobile Broadband (eMBB) services to other UEs, and/or Massive Machine Type Communication (mM TC)/Massive IoT services to yet further UEs.

In some examples, UEs 1712 are configured to transmit and/or receive information without direct human interaction. For instance, a UE may be designed to transmit information to access network 1704 on a predetermined schedule, when triggered by an internal or external event, or in response to requests from access network 1704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, hub 1714 communicates with access network 1704 to facilitate indirect communication between one or more UEs (e.g., UE 1712c and/or 1712d) and network nodes (e.g., network node 1710b). In some examples, hub 1714 may be a controller, router, content source and analytics, or any of the other communication devices described herein regarding UEs. For example, hub 1714 may be a broadband router enabling access to core network 1706 for the UEs. As another example, hub 1714 may be a controller that sends commands or instructions to one or more actuators in the UEs. Commands or instructions may be received from the UEs, network nodes 1710, or by executable code, script, process, or other instructions in hub 1714. As another example, hub 1714 may be a data collector that acts as temporary storage for UE data and, in some embodiments, may perform analysis or other processing of the data. As another example, hub 1714 may be a content source. For example, for a UE that is a VR headset, display, loudspeaker or other media delivery device, hub 1714 may retrieve VR assets, video, audio, or other media or data related to sensory information via a network node, which hub 1714 then provides to the UE either directly, after performing local processing, and/or after adding additional local content. In still another example, hub 1714 acts as a proxy server or orchestrator for the UEs, in particular if one or more of the UEs are low energy IoT devices.

Hub 1714 may have a constant/persistent or intermittent connection to network node 1710b. Hub 1714 may also allow for a different communication scheme and/or schedule between hub 1714 and UEs (e.g., UE 1712c and/or 1712d), and between hub 1714 and core network 1706. In other examples, hub 1714 is connected to core network 1706 and/or one or more UEs via a wired connection. Moreover, hub 1714 may be configured to connect to an M2M service provider over access network 1704 and/or to another UE over a direct connection. In some scenarios, UEs may establish a wireless connection with network nodes 1710 while still connected via hub 1714 via a wired or wireless connection. In some embodiments, hub 1714 may be a dedicated hub—that is, a hub whose primary function is to route communications to/from the UEs from/to network node 1710b. In other embodiments, hub 1714 may be a non-dedicated hub-that is, a device which is capable of operating to route communications between the UEs and network node 1710b, but which is additionally capable of operating as a communication start and/or end point for certain data channels.

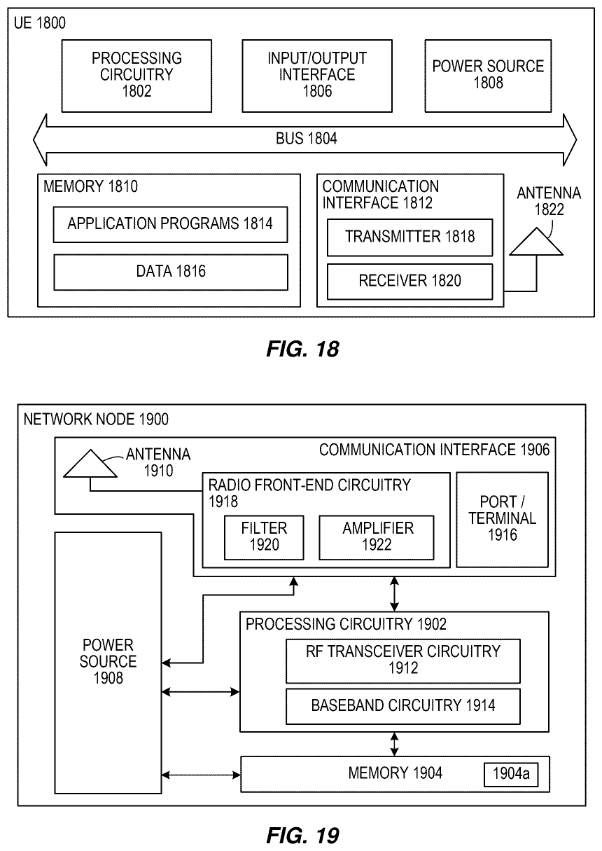

FIG. 18 shows a UE 1800 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

Processing circuitry 1802 is configured to process instructions and data and may be configured to implement any sequential state machine operative to execute instructions stored as machine-readable computer programs in memory 1810. Processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1802 may include multiple central processing units (CPUs).

In the example, input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1808 is structured as a battery or battery pack. Other types of power sources, such as an external power source (e.g., an electricity outlet), photovoltaic device, or power cell, may be used. Power source 1808 may further include power circuitry for delivering power from power source 1808 itself, and/or an external power source, to the various parts of UE 1800 via input circuitry or an interface such as an electrical power cable. Delivering power may be, for example, for charging of power source 1808. Power circuitry may perform any formatting, converting, or other modification to the power from power source 1808 to make the power suitable for the respective components of UE 1800 to which power is supplied.

Memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1810 includes one or more application programs 1814, such as an operating system, web browser application, a widget, gadget engine, or other application, and corresponding data 1816. Memory 1810 may store, for use by UE 1800, any of a variety of various operating systems or combinations of operating systems.

Memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1810 may allow UE 1800 to access instructions, application programs and the like, stored on transitory or non-transitory memory media, to off-load data, or to upload data. An article of manufacture, such as one utilizing a communication system may be tangibly embodied as or in memory 1810, which may be or comprise a device-readable storage medium.

Processing circuitry 1802 may be configured to communicate with an access network or other network using communication interface 1812. Communication interface 1812 may comprise one or more communication subsystems and may include or be communicatively coupled to an antenna 1822. Communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, transmitter 1818 and receiver 1820 may be coupled to one or more antennas (e.g., antenna 1822) and may share circuit components, software, or firmware, or alternatively be implemented separately.

In the illustrated embodiment, communication functions of communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (M SR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1900 includes processing circuitry 1902, memory 1904, communication interface 1906, and power source 1908. Network node 1900 may be composed of multiple physically separate components (e.g., a NodeB component and a RNC component, or a BTS component and a BSC component, etc.), which may each have their own respective components. In certain scenarios in which network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). Network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

Processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as memory 1904, to provide network node 1900 functionality.

In some embodiments, processing circuitry 1902 includes a system on a chip (SOC). In some embodiments, processing circuitry 1902 includes radio frequency (RF) transceiver circuitry 1912 and/or baseband processing circuitry 1914. In some embodiments, RF transceiver circuitry 1912 and/or baseband processing circuitry 1914 may be on separate chips (or sets of chips), boards, or units, such as radio units and digital units. In alternative embodiments, part or all of RF transceiver circuitry 1912 and/or baseband processing circuitry 1914 may be on the same chip or set of chips, boards, or units.

Memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1902. Memory 1904 may store any suitable instructions, data, or information, including a computer program, software, an application including one or more of logic, rules, code, tables, and/or other instructions (collected denoted computer program 1904a, which may be in the form of a computer program product) capable of being executed by processing circuitry 1902 and utilized by network node 1900. Memory 1904 may be used to store any calculations made by processing circuitry 1902 and/or any data received via communication interface 1906. In some embodiments, processing circuitry 1902 and memory 1904 is integrated.

Communication interface 1906 is used in wired or wireless communication of signaling and/or data between a network node, access network, and/or UE. As illustrated, communication interface 1906 comprises port(s)/terminal(s) 1916 to send and receive data, for example to and from a network over a wired connection. Communication interface 1906 also includes radio front-end circuitry 1918 that may be coupled to, or in certain embodiments a part of, antenna 1910. Radio front-end circuitry 1918 comprises filters 1920 and amplifiers 1922. Radio front-end circuitry 1918 may be connected to an antenna 1910 and processing circuitry 1902. The radio front-end circuitry may be configured to condition signals communicated between antenna 1910 and processing circuitry 1902. Radio front-end circuitry 1918 may receive digital data that is to be sent out to other network nodes or UEs via a wireless connection. Radio front-end circuitry 1918 may convert the digital data into a radio signal having the appropriate channel and bandwidth parameters using a combination of filters 1920 and/or amplifiers 1922. The radio signal may then be transmitted via antenna 1910. Similarly, when receiving data, antenna 1910 may collect radio signals which are then converted into digital data by radio front-end circuitry 1918. The digital data may be passed to processing circuitry 1902. In other embodiments, the communication interface may comprise different components and/or different combinations of components.

In certain alternative embodiments, network node 1900 does not include separate radio front-end circuitry 1918, instead, processing circuitry 1902 includes radio front-end circuitry and is connected to antenna 1910. Similarly, in some embodiments, all or some of RF transceiver circuitry 1912 is part of communication interface 1906. In still other embodiments, communication interface 1906 includes one or more ports or terminals 1916, radio front-end circuitry 1918, and RF transceiver circuitry 1912, as part of a radio unit (not shown), and communication interface 1906 communicates with baseband processing circuitry 1914, which is part of a digital unit (not shown).

Antenna 1910 may include one or more antennas, or antenna arrays, configured to send and/or receive wireless signals. Antenna 1910 may be coupled to radio front-end circuitry 1918 and may be any type of antenna capable of transmitting and receiving data and/or signals wirelessly. In certain embodiments, antenna 1910 is separate from network node 1900 and connectable to network node 1900 through an interface or port.

Antenna 1910, communication interface 1906, and/or processing circuitry 1902 may be configured to perform any receiving operations and/or certain obtaining operations described herein as being performed by the network node. Any information, data and/or signals may be received from a UE, another network node and/or any other network equipment. Similarly, antenna 1910, communication interface 1906, and/or processing circuitry 1902 may be configured to perform any transmitting operations described herein as being performed by the network node. Any information, data and/or signals may be transmitted to a UE, another network node and/or any other network equipment.

Power source 1908 provides power to the various components of network node 1900 in a form suitable for the respective components (e.g., at a voltage and current level needed for each respective component). Power source 1908 may further comprise, or be coupled to, power management circuitry to supply the components of network node 1900 with power for performing the functionality described herein. For example, network node 1900 may be connectable to an external power source (e.g., the power grid, an electricity outlet) via an input circuitry or interface such as an electrical cable, whereby the external power source supplies power to power circuitry of power source 1908. As a further example, power source 1908 may comprise a source of power in the form of a battery or battery pack which is connected to, or integrated in, power circuitry. The battery may provide backup power should the external power source fail.

Embodiments of network node 1900 may include additional components beyond those shown in FIG. 19 for providing certain aspects of the network node's functionality, including any of the functionality described herein and/or any functionality necessary to support the subject matter described herein. For example, network node 1900 may include user interface equipment to allow input of information into network node 1900 and to allow output of information from network node 1900. This may allow a user to perform diagnostic, maintenance, repair, and other administrative functions for network node 1900.

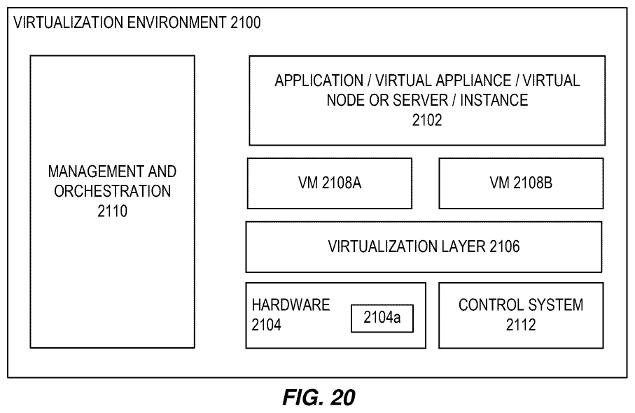

FIG. 20 is a block diagram of a host 2000, which may be an embodiment of host 1716 of FIG. 17, in accordance with various aspects described herein. As used herein, host 2000 may be or comprise various combinations hardware and/or software, including a standalone server, a blade server, a cloud-implemented server, a distributed server, a virtual machine, container, or processing resources in a server farm. Host 2000 may provide one or more services to one or more UEs.

FIG. 20 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2100 includes components defined by the O-RAN Alliance, such as an O-Cloud environment orchestrated by a Service Management and Orchestration Framework via an O-2 interface.

Applications 2102 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2104 includes processing circuitry, memory that stores software and/or instructions (collected denoted computer program 2104a, which may be in the form of a computer program product) executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VM s 2108a and 2108b (one or more of which may be generally referred to as VMs 2108), and/or perform any of the functions, features and/or benefits described in relation with some embodiments described herein. Virtualization layer 2106 may present a virtual operating platform that appears like networking hardware to the VM s 2108.

VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2108 may be a software implementation of a physical machine that runs programs as if they were executing on a physical, non-virtualized machine. Each VM 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration function 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1. A method performed by a radio access network, RAN, node for communication with one or more user equipment, UEs, the method comprising:
prior to a first packet being transmitted, predicting likelihood of decoding success by a receiver of the first packet, using a machine learning, ML, model with the following inputs:
one or more parameters representative of characteristics of a radio channel over which the first packet will be transmitted, wherein the one or more parameters represent characteristics of the radio channel during a plurality of regularly spaced time periods preceding the transmission of the first packet, and
candidates of one or more of the following for the first packet: modulation and coding scheme, MCS, and number of physical resource blocks, PRBs;
obtaining a first MCS and/or a first number of PRBs to be used for transmission of the first packet, based on the one or more candidates and the predicted likelihood of decoding success; and
transmitting or receiving the first packet using the obtained first MCS and/or first number of PRBs.

2. The method of claim 1, wherein:
the first packet is a downlink, DL, packet transmitted by the RAN node to a first UE using the first MCS; and
the method further comprises receiving from the first UE an indication of decoding success or failure for the first packet, wherein the indication received from the UE is one of the following: a hybrid ARQ, HARQ, acknowledgement, ACK, indicating decoding success; or a HARQ negative ACK, NACK, indicating decoding failure.

3. The method of claim 1, wherein:
the first packet is an uplink, UL, packet received by the RAN node from the first UE using the first MCS; and
receiving the first packet comprises determining whether the received first packet can be successfully decoded using the first MCS.

4. The method of claim 1, further comprising, before transmitting or receiving the first packet, transmitting to the UE an indication of the first MCS and one of the following: a grant of uplink, UL, resources for UE transmission of the first packet; or an indication of downlink, DL, resources in which the first packet will be transmitted by the RAN node.

5. The method of claim 1, wherein obtaining the first MCS comprises:
when the predicted likelihood of decoding success is at least a threshold, selecting the candidate MCS as the first MCS; and
when the predicted likelihood of decoding success is less than the threshold, selecting as the first MCS a second candidate MCS that is more robust and/or has lower capacity than the candidate MCS.

6. The method of claim 1, wherein obtaining the first number of PRBs comprises:
when the predicted likelihood of decoding success is at least a threshold, selecting the candidate number of PRBs as the first number of PRBs; and
when the predicted likelihood of decoding success is less than the threshold, selecting as the first number of PRBs a second number of PRBs that is smaller than the candidate number of PRBs.

7. The method of claim 1, wherein obtaining the first MCS and the first number of PRBs comprises:
when the predicted likelihood of decoding success is at least a threshold, selecting the candidate MCS as the first MCS and the candidate number of PRBs as the first number of PRBs; and
when the predicted likelihood of decoding success is less than the threshold, selecting one or more of the following as the first MCS and the first number of PRBs:
a second number of PRBs that is smaller than the candidate number of PRBs, and
a second MCS that is more robust and/or has lower capacity than the candidate MCS.

8. The method of claim 1, wherein:
predicting likelihood of decoding success for the first packet using the ML model is performed for a plurality of different combinations of candidate MCS and candidate number of PRBs; and
obtaining the first MCS comprises:
when the predicted likelihood of decoding success for at least one of the combinations is at least a threshold, selecting as the first MCS and the first number of PRBs the least robust and/or highest capacity combination for which the predicted likelihood of decoding success is at least the threshold; and
when the predicted likelihood of decoding success for all of the combinations is less than the threshold, selecting as the first MCS and the first number of PRBs the most robust and/or lowest capacity combination.

9. The method of claim 1, wherein the parameters representative of characteristics of the radio channel include one or more of the following:
uplink, UL, signal-to-interference-and-noise ratio, SINR, measured by the RAN node;
downlink, DL, channel state information, CSI, reported by the one or more UEs;
an index associated with a beam used to communicate with the UE;
indications of decoding success or failure reported by the one or more UEs for DL packets previously transmitted by the RAN node;
indications of decoding success or failure by the RAN node for UL packets previously transmitted by the one or more UEs; and
timing adjustments for UL packets previously transmitted by the one or more UEs.

10. The method of claim 9, further comprising:
maintaining a channel state for link adaptation, CS4LA, based on one or more of the following: the indications of decoding success or failure reported by the one or more UEs for the DL packets, and the indications of decoding success or failure by the RAN node for the UL packets; and
obtaining the candidate MCS based on the CS4LA.

11. The method of claim 10, wherein maintaining the CS4LA comprises:
incrementing the CS4LA by a first amount based on an indication of decoding success; and
decrementing the CS4LA by a second amount based on an indication of decoding failure, with the second amount being larger than the first amount.

12. The method of claim 11, wherein when the predicted likelihood of decoding success for the first packet using the candidate MCS is less than a threshold, the obtained first MCS is less robust and/or has higher capacity than a further candidate MCS obtained based on the CS4LA decremented by the second amount.

13. The method of claim 1, wherein the ML model is a recurrence neural network, RNN, comprising an input layer configured to receive input, an output layer configured to output a predicted likelihood of decoding success by a receiver of the first packet, and two or more fully connected hidden layers intermediate between the input layer and the output layer.

14. The method of claim 13, wherein:
the input to the input layer is a feature vector; and
predicting likelihood of decoding success by a receiver of the first packet using the ML model comprises determining the feature vector based on a function of the following: the candidate MCS for the first packet, and the one or more parameters representative of characteristics of the radio channel over which the first packet will be transmitted.

15. The method of claim 1, wherein:
the method further comprises receiving the ML model from one of the following:
a network node or function, NNF, in a core network coupled to the RAN, or a server in a cloud computing environment coupled to the RAN;
the received ML model has been trained on plurality of samples logged in a cell served by the RAN node; and
each sample corresponds to a respective packet and includes the following:
an MCS used for transmission of the packet,
an indication of decoding success or failure by a receiver of the packet, and
one or more parameters representative of characteristics of a radio channel over which the packet was transmitted.

16. A radio access network, RAN, node configured for communication with one or more user equipment, UEs, the RAN node comprising:
communication interface circuitry configured to communicate with the one or more UEs; and
processing circuitry operatively coupled to the communication interface circuitry, whereby the processing circuitry and the communication interface circuitry are configured to:
prior to a first packet being transmitted, predict likelihood of decoding success by a receiver of the first packet, using a machine learning, ML, model with the following inputs:
one or more parameters representative of characteristics of a radio channel over which the first packet will be transmitted, wherein the one or more parameters represent characteristics of the radio channel during a plurality of regularly spaced time periods preceding the transmission of the first packet, and
candidates of one or more of the following for the first packet: modulation and coding scheme, MCS, and number of physical resource blocks, PRBs;
obtain a first MCS and/or a first number of PRBs to be used for transmission of the first packet, based on the one or more candidates and the predicted likelihood of decoding success; and
transmit or receive the first packet using the obtained first MCS and/or first number of PRBs.

17. The RAN node of claim 16, wherein:
the first packet is a downlink, DL, packet transmitted by the RAN node to a first UE using the first MCS; and
the processing circuitry and the communication interface circuitry are configured to receive from the first UE an indication of decoding success or failure for the first packet, wherein the indication received from the UE is one of the following: a hybrid ARQ, HARQ, acknowledgement, ACK, indicating decoding success; or a HARQ negative ACK, NACK, indicating decoding failure.
